(19) United States
(12) Patent Application Publication
(10) Pub. No.: US 2012/0229412 A1
(43) Pub. Date: Sep. 13, 2012

(54) Touch Position Detection Method and Apparatus

(75) Inventor: Juha Harri-Pekka Nurmi, Salo (FI)

(73) Assignee: NOKIA CORPORATION, Espoo (FI)

(21) Appl. No.: 13/512,715

(22) PCT Filed: Nov. 30, 2009
(86) PCT No.: PCT/EP2009/066083

§ 371 Date: May 30, 2012

(51) Int. Cl. G06F 3/041

(52) U.S. Cl. 345/173; 178/18.03

(57) ABSTRACT

A method comprising: a) concurrently selecting a group of rows in a sensor network; b) simultaneously reading at least one column of the sensor network to detect a sensing event; c) if a sensing event is not detected, eliminating the group of rows from further selection.

### FIELD OF THE INVENTION

Embodiments of the present invention relate to a sensor and in particular a sensor network and a method of using a sensor network.

### BACKGROUND TO THE INVENTION

A matrix sensor network comprises sensor elements arranged on a grid or matrix. The grid or matrix comprises a plurality of row lines (rows) and a plurality of column lines (columns). Each sensor element is associated with a unique combination of a row and a column.

Typically a single row is selected and all the columns are read to detect a sensing event at any sensor associated with the selected row and any one of the columns.

### BRIEF DESCRIPTION OF VARIOUS EMBODIMENTS OF THE INVENTION

According to various, but not necessarily all, embodiments of the invention there is provided a method comprising: concurrently selecting a group of rows in a sensor network; simultaneously reading at least one column of the sensor network to detect a sensing event; and if a sensing event is not detected, eliminating the group of rows from further selection.

According to various, but not necessarily all, embodiments of the invention there is provided a method comprising: an apparatus comprising: a sensor network comprising: a first plurality of rows, a second plurality of columns, and a third plurality of sensor elements wherein each sensor element is associated with a unique combination of a row and a column; selection circuitry configured to concurrently select one or more of the first plurality of rows; reading circuitry configured to concurrently read the second plurality of columns during a concurrent selection; and control circuitry configured to select which of the first plurality of rows are selected and, if no sensing event is detected by the reading circuitry during a concurrent selection of selected rows, then eliminating the selected rows from further selection.

According to various, but not necessarily all, embodiments of the invention there is provided an apparatus comprising: a sensor network array comprising: a first plurality of rows; a second plurality of columns; a third plurality of sensor elements wherein each sensor element is associated with a unique combination of a row and a column; means for concurrently selecting one or more of the first plurality of rows; means for concurrently reading columns during a concurrent selection of rows;

means for determining which of the first plurality of rows are selected and, if no sensing event is detected by the reading circuitry during a concurrent selection of rows, then eliminating the selected rows from further selection.

### BRIEF DESCRIPTION OF THE DRAWINGS

For a better understanding of various examples of embodiments of the present invention reference will now be made by way of example only to the accompanying drawings in which:

FIG. 1 schematically illustrates an apparatus;

FIG. 2 schematically illustrates a record carrier;

FIG. 3 schematically illustrates a matrix sensor network;

FIG. 4 schematically illustrates a method for the identification of a co-ordinate for a single sensing event;

FIGS. 5A to 5C schematically illustrate different applications of the method;

FIG. 6 schematically illustrates a method for the identification of co-ordinates for multiple simultaneous sensing events;

FIG. 7 schematically illustrates an additional block for the method for the identification of co-ordinates for multiple simultaneous sensing events;

FIG. 8 schematically illustrates an applications of the method; and

FIG. 9 schematically illustrates a graph.

### DETAILED DESCRIPTION OF VARIOUS EMBODIMENTS OF THE INVENTION

Some embodiments described below relate to a method comprising:

a) concurrently selecting a group of rows in a sensor network;
b) simultaneously reading at least one column of the sensor network to detect a sensing event; and
c) if a sensing event is not detected, eliminating the group of rows from further selection.

This process is repeated to identify the row (and column) at which a sensing event occurs. Elimination of groups of rows from further selection reduces the ‘search space’ that is searched to find a solution e.g. the row of the sensing event. A solution may, for example, be determined by reducing a search space, which is known to contain the row of a sensing event, to a single row.

The search space may be reductively searched, for example, the search space may be divided into sub-spaces and each sub-space may be separately searched using the above described process of elimination e.g.

a) concurrently selecting a group of rows in a sensor network corresponding to the sub-space;
b) simultaneously reading at least one column of the sensor network to detect a sensing event; and
c) if a sensing event is not detected, eliminating the group of rows corresponding to the sub-space from further selection.

The sub-spaces may be non-overlapping. Each sub-space may also be reductively searched using the above described process of elimination.

For single touch sensing, the process may continue until a solution is found.

For multiple touch sensing, the process may continue until it is determined that every row has either been eliminated or is a solution.

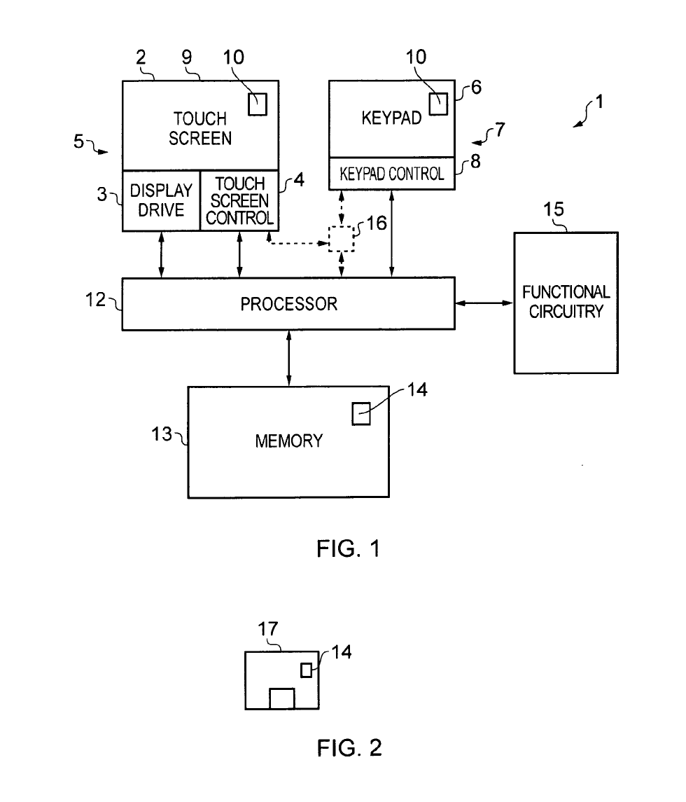

FIG. 1 schematically illustrates an apparatus 1 comprising one or more matrix sensor networks 10. A matrix sensor network 10 may optionally be a part of a touch screen 2 or may optionally be part of a keypad 6. In the illustrated example, a first matrix sensor network 10 is a part of the touch screen 2 and a second matrix sensor network 10 is part of the keypad 6.

In the FIG. 1, a touch screen module 5 comprises: a touch screen 2 that includes a matrix sensor network 10 and a touch screen controller 4 for controlling the touch screen 2 as an input device. It may also comprise a display driver 3 for controlling a display panel 9 as an output device. The touch screen 2 may be a display integrated touch screen. The touch screen controller 4 may be implemented entirely in hardware or alternatively implemented using a combination of hardware and software.

In the FIG. 1, a keypad module 7 comprises: a keypad 6 that includes a matrix sensor network 10; and a keypad controller 8 for controlling the keypad 6 as an input device. The keypad controller 8 may be implemented entirely in hardware or alternatively implemented using a combination of hardware and software.

A processor 12 is connected to the touch screen module 5, the keypad module 7 a memory 13 and functional circuitry 15. The memory 13 stores a computer program 14. The processor 12 is configured to read from and write to the memory 13.

The functional circuitry 15 represents circuitry that performs functions that are ancillary to the control of the matrix sensor network 10 but which provide functionality to the apparatus 1.

Control circuitry for the intelligent control of a matrix sensor network 10 in the touch screen 2 may be provided within the touch screen controller 4 and/or the processor 12 under the control of the computer program 14.

Control circuitry for the intelligent control of a matrix sensor network 10 in the keypad 6 may be provided by the keypad controller 8 and/or the processor 12 under the control of the computer program 14.

Any such control circuitry provided by the processor 12 under the control of the computer program 14 may, instead, be integrated into an optional control module 16. The control module 16 may be implemented entirely in hardware or alternatively implemented using a combination of hardware and software.

The term ‘apparatus’ may refer to the apparatus 1 or any sub-component of the apparatus 1.

The memory 13 stores a computer program 14 comprising computer program instructions that control the operation of the apparatus 1 when loaded into the processor 12. The computer program instructions 14 provide the logic and routines that enables the apparatus to perform the methods described below and/or illustrated in the Figures. The processor 12 by reading the memory 13 is able to load and execute the computer program 14.

The computer program 14 may arrive at the apparatus 1 via any suitable delivery mechanism 17 such as illustrated in FIG. 2. The delivery mechanism 17 may be, for example, a computer-readable storage medium, a computer program product, a memory device, a record medium, an article of manufacture that tangibly embodies the computer program 14. The delivery mechanism may be a signal configured to reliably transfer the computer program 14. The apparatus 1 may propagate or transmit the computer program 14 as a computer data signal.

Although the memory 13 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

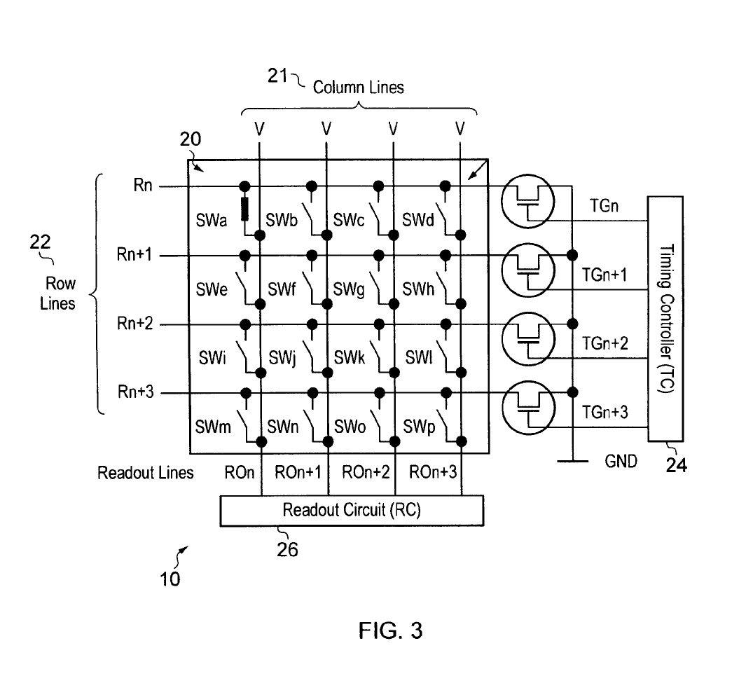

FIG. 3 schematically illustrates a matrix sensor network 10. This example of a matrix sensor network 10 comprises sensor elements SW arranged on a grid or matrix 20. The grid or matrix 20 comprises a first plurality of row lines (rows) 22 and a second plurality of column lines (columns) 21. Each sensor element SW is associated with a unique combination of a row 22 and a column 21.

A timing controller block 24 operates as selection circuitry and is configured to concurrently select a group of the first plurality of rows. The group may contain one or more rows. The timing controller 24 is therefore able to control scanning of the matrix sensor network group by group as opposed to single row by single row.

A reading block 26 operates as reading circuitry to detect a sensing event. The reading circuitry is configured to concurrently read the second plurality of columns 21 during a simultaneous concurrent selection or to read one or some of the second plurality of columns 21 during a simultaneous concurrent selection.

If a sensing event is occurring at a sensor element SW and the row 22 associated with that sensing element SW is selected, then the column 21 associated with that sensing element SW will indicate a sensing event that is detected by the reading block 26.

There is typically a minimum signal time required for an accurate read. Consequently, the timing controller 24 concurrently selects a group of the first plurality of rows in separate time slots which have a certain minimum duration.

The reading block 26 detects a sensing event but it may be occurring at one or more of the rows in the concurrently selected group of rows.

Control circuitry (not illustrated in this figure but discussed in relation to FIG. 1) is configured to determine which group of the first plurality of rows 22 is to be selected and, if no sensing event is detected by the reading circuitry 26 during a concurrent selection of that group of rows, to eliminate that group of rows from further selection.

The control circuitry determines a co-ordinate of a sensing event by identifying the row and column of the sensing event.

In this application the term ‘row’ is used to signify a line that is selected to obtain a read-out from a sensor element. The term ‘column’ is used to signify a line that is used to obtain a read-out from a sensor element. It is does not necessarily imply any orientation to the horizontal or vertical.

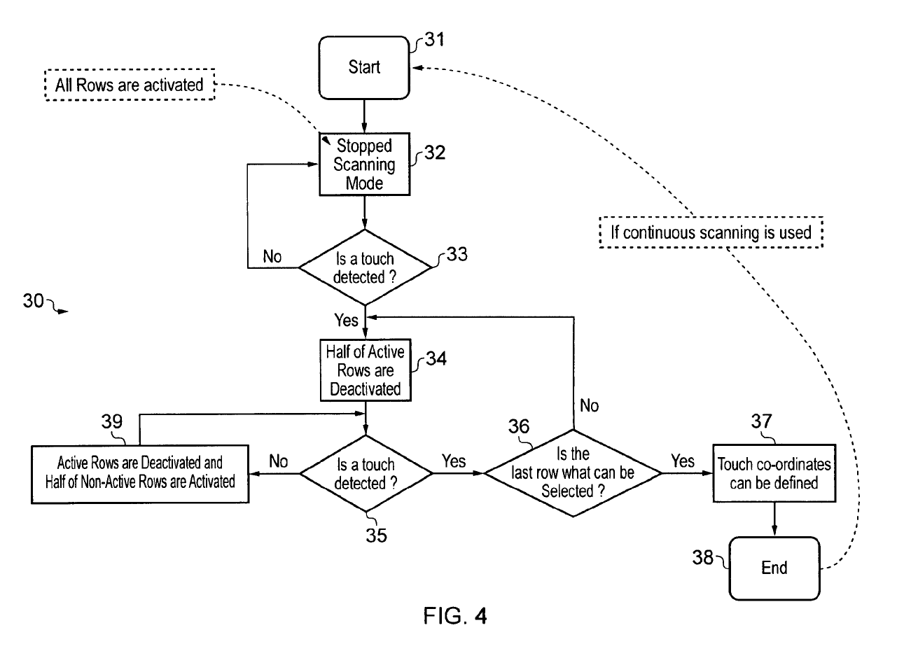

FIG. 4 schematically illustrates a method 30 for the identification of a coordinate for a single sensing event.

The method 30 starts at block 31.

Next at block 32 concurrent selection of a group of rows in the matrix sensor network 10 occurs along with simultaneous reading of all of the columns of the matrix sensor network to detect a sensing event. The group of rows consists of all the rows of the matrix sensor network 10.

Next at block 33, it is determined whether or not a sensing event is detected. If a sensing event is not detected the method returns to block 32. If a sensing event is detected, the method moves to block 34. The column associated with the sensing event, the sensing column may or may not be recorded.

At block 34 concurrent selection of a new group of rows in the matrix sensor network 10 occurs along with simultaneous reading of at least one of the columns of the matrix sensor network 10 to detect the sensing event. For example, the simultaneous reading may occur for only the sensing column or it may occur concurrently for all columns. In this example, the new group of rows for concurrent selection is formed by halving the previously defined group of rows.

Next at block 35, it is determined whether or not a sensing event is detected during the concurrent selection of the new group of rows. If a sensing event is not detected the method moves to block 39. If a sensing event is detected, the method moves to block 36.

At block 39, the currently defined group of rows is eliminated from further selection.

In this example, a new group of rows is formed by taking the other half of the previously defined group of rows that was not selected at block 34. Then concurrent selection of the new group of rows in the matrix sensor network 10 occurs along with simultaneous reading of at least one of the columns of the matrix sensor network to detect the sensing event. For example, the simultaneous reading may occur for only the sensing column or it may occur concurrently for all columns. The method then moves back to step 35.

At block 36, it is determined whether the current group of rows comprises the last row that has not been eliminated. If this is not the case, the method moves to block 34. If it is the case, the method moves to block 37.

At block 37, the row associated with the current group of rows is identified as the ‘selected row’. The co-ordinate of the sensing event can then be identified as the sensing column and the ‘selected row’.

Next at block 38, the method ends. The elimination of rows is cancelled and the method is ready to restart at block 31.

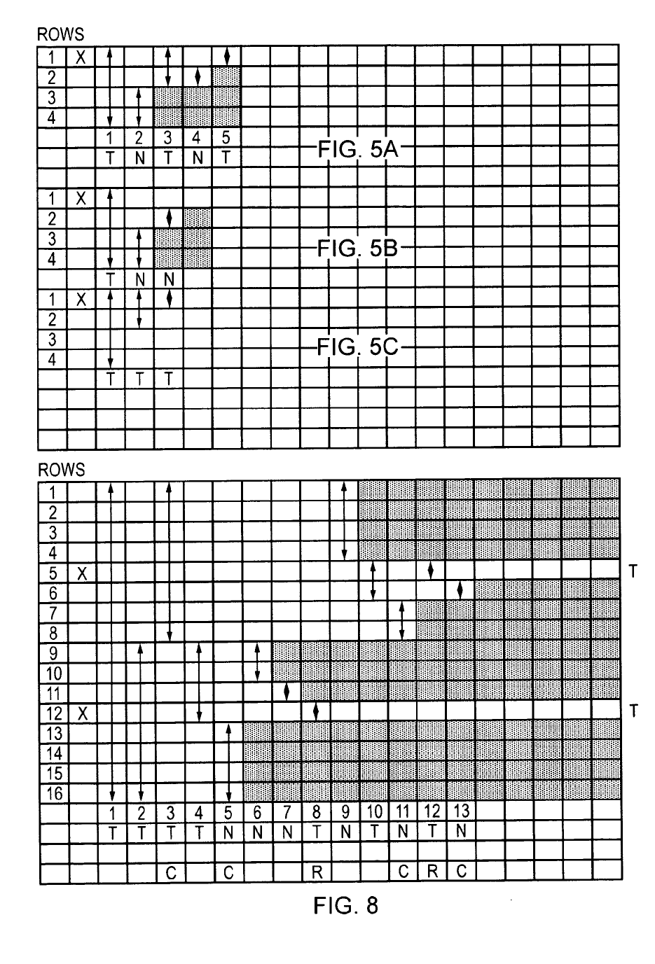

FIGS. 5A to 5C schematically illustrate different applications of the method In the illustrated tables, the rows are labelled in the first column. In the examples of FIGS. 5A to 5C, there are four rows. The second column indicates where a sensing event occurs. In the examples of FIGS. 5A to 5C, there is a sensing event at row 1. The remaining columns indicate time slots.

In each time slot (numbered 1 to 5) a different group of rows is concurrently selected and accompanied by a simultaneously reading of at least one column of the matrix sensor network to detect a sensing event. The detection of a sensing event is labelled using T in the time slot. The non-detection of a sensing event is labelled using N in the timeslot. The rows selected in a particular time slot are indicated using a two-headed arrow.

FIG. 5A illustrates a sub-optimal method.

Slot 1: All rows are selected to detect a sensing event. A sensing event is detected (T).

Slot 2: The lower half of the rows (rows 3 & 4) are selected to detect a sensing event. A sensing event is not detected (N). The lower half of the rows (rows 3 & 4) are eliminated for subsequent time slots as indicated by dark shading.

Slot 3: The upper half of the rows (rows 1 & 2) are selected to detect a sensing event. A sensing event is detected (T).

Slot 4: The lower half of the upper half of the rows (row 2) is selected to detect a sensing event. A sensing event is not detected (N). The lower half of the upper half of the rows (row 2) is eliminated for subsequent time slots as indicated by dark shading.

Slot 5: The upper half of the upper half of the rows (row 1) is selected to detect a sensing event. A sensing event is detected (T). This is the last row available for selection and therefore provides the sensing row as row 1.

It should be appreciated that this method is sub-optimal. The slot 3 is not required, as it can be determined from logic based on the outcome of slots 1 and 2 that the sensing event occurs in the upper half of the rows (rows 1 & 2). Also the slot 5 is not required, as it can be determined from logic based on the outcome of slots 1, 2 and 4 that sensing event occurs in row 1.

FIG. 5B illustrates an optimal method in accordance with FIG. 4.

Slot 1: All rows are selected to detect a sensing event. A sensing event is detected (T).

Slot 2: The lower half of the rows (rows 3 & 4) are selected to detect a sensing event. A sensing event is not detected (N). The lower half of the rows (rows 3 & 4) are eliminated for subsequent time slots as indicated by dark shading.

Slot 3: The lower half of the upper half of the rows (row 2) is selected to detect a sensing event. A sensing event is not detected (N). The lower half of the upper half of the rows (row 2) is eliminated for subsequent time slots as indicated by dark shading. The last row (row 1) is only available for selection and therefore must be the sensing row.

FIG. 5C illustrates a top-first, bottom-second approach in comparison to the bottom-first, top-second approach of FIGS. 5A and 5B. That is, at block 34, the upper half is selected instead of the lower half.

Slot 1: All rows are selected to detect a sensing event. A sensing event is detected (T).

Slot 2: The upper half of the rows (rows 1 & 2) are selected to detect a sensing event. A sensing event is detected (T).

Slot 3: The upper half of the upper half of the rows (row 1) is selected to detect a sensing event. A sensing event is detected (T). This is single row and therefore identifies the sensing row as row 1.

Thus, referring to FIGS. 5B, 5C and FIG. 4, if a single sensing event is detected at a column, while a group of rows are concurrently selected (block 35; slot 1 FIGS. 5B, 5C), then the method comprises concurrently re-selecting a second group of rows consisting of a first subset of the group of rows, while at least the column of the matrix sensor network is simultaneously read (block 34; slot 2 FIGS. 5B, 5C). If a sensing event is detected (FIG. 5C) with respect to the second group of rows (block 35), then the method comprises concurrently re-selecting a second subset of the second group of rows while at least the column of the matrix sensor network is simultaneously read (block 34). However, if instead a sensing event is not detected (FIG. 5B) with respect to the second group of rows (rows 3 & 4 FIG. 5B), then the method comprises (block 39 FIG. 4) concurrently re-selecting a third subset (row 2 FIG. 5B) of a third group of rows (rows 1 & 2 FIG. 5B) while at least the column of the matrix sensor network is simultaneously read, wherein the third group of rows (rows 1 & 2 FIG. 5B) consists of a different second subset of the group of rows (rows 1, 2, 3, 4 FIG. 5B).

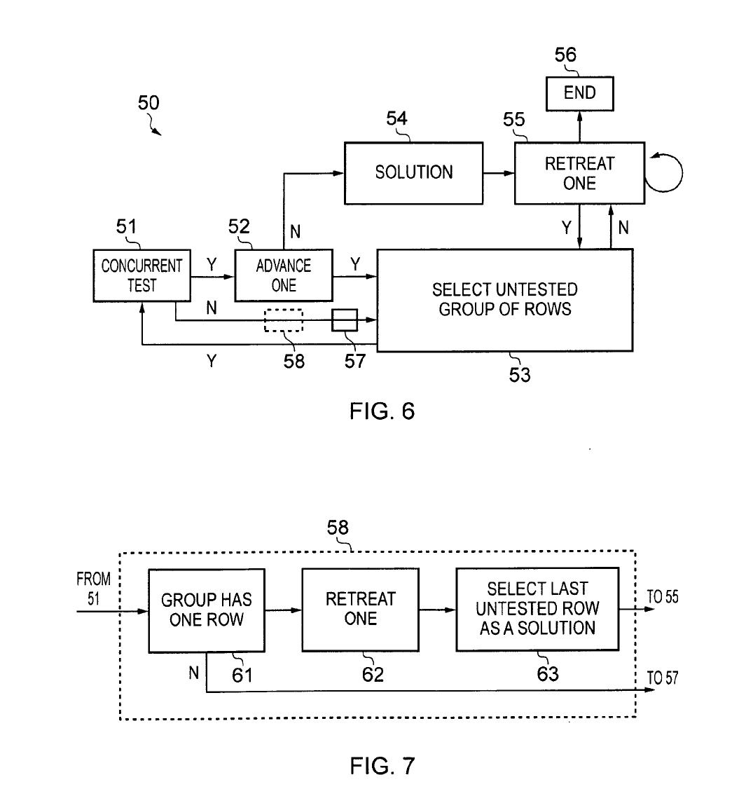

FIG. 6 schematically illustrates a method for the identification of co-ordinates for multiple simultaneous sensing events

The method 50 starts at block 53, where a group of rows is concurrently selected. The group will not have previously been selected. Initially the group may consist of all of the rows.

The method then moves to block 51, where simultaneously reading of at least one column of the matrix sensor network to detect a sensing event occurs. If a sensing event is detected the method moves to block 52 and if a sensing event is not detected the method returns to block 57.

At block 57, the current group of rows is eliminated from further selection reducing the pool of rows from which selection of a group of rows can be made. A new group of rows for concurrent selection at block 53 is defined from the available pool of rows. The new group will not have previously been selected. The method then moves to block 53. Thus if a group of rows is selected but a sensing event is not detected, that group of rows is eliminated from further selection

As an example, the definition of a new group of rows for concurrent selection may by defining a new larger group of rows for which the current group of rows is a sub set and determining as the new group of rows for concurrent selection a subset of the larger group of rows and has not been previously defined for selection. If it is not possible to define such a new group, the method moves to block 54 other wise it moves to block 53.

At block 52, a new group of rows for concurrent selection at block 53 is defined that is a subset of the current group of rows. The method then moves to block 53. Thus if a group of rows is selected but a sensing event is detected, that group of rows is further searched for the sensing event.

If at block 52, it is not possible to define a new group of rows for concurrent selection that is a subset of the current group of rows and that has not have previously defined for selection, then the method moves to block 54.

At block 54, the current group of rows consists of a single row that is a sensing row solution.

After block 54, the method moves to block 55, where a new larger group of rows is defined for which the current group of rows is a sub set. A new group of rows for concurrent selection at block 53 is defined that is a subset of the larger group of rows and has not been previously selected. The method then moves to block 53.

If, it is not possible to define a new group of rows for concurrent selection that is a subset of the larger group of rows and that has not been previously selected, then the block 54 is re-entered and repeated. This block therefore searches out as yet unselected groups of rows.

At block 53, the newly defined group of rows is concurrently selected if it has not been previously selected. Then the method moves to block 51 again. If the newly defined group has been previously selected then the method moves to block 55.

If it is not possible to define a new larger group of rows at block 55, then the method ends at block 56. All groups have either been eliminated or selected.

FIG. 7 schematically illustrates an additional block 58 for the method for the identification of co-ordinates for multiple simultaneous sensing events.

This block uses logic to determine a row as a solution without testing that row.

If a group comprises a pair of rows and is successfully tested, then a group consisting of one of the pair of rows is tested. If that test fails, it can be deduced that the other one of the pair of rows would pass the test.

Initially block 62 determines whether the current group consists of one row. If it does not, block 58 is exited and block 57 is entered. If it does, block 62 is entered.

At block 61, a new larger group of rows is defined (the pair) for which the current row is a sub set. A new group of rows (the other row of the pair) is defined that is a subset of the larger group of rows (the pair) and has not been previously selected.

Then at block 63 the new group of rows consisting of a single row is identified as a sensing row solution. The method then moves to block 55.

Therefore, if a sensing event is detected at a column, while the group of rows are concurrently selected, and the group of rows consists of only a pair of rows, then the method (52, 53) re-selects one of the pair of rows while at least the column of the matrix sensor network is simultaneously read. If a sensing event is not detected (51) the column and the other one of the pair of rows is identified (58) as a co-ordinate of a sensing event. If a sensing event is detected (51), the column and the re-selected one of the pair of rows are identified (52, 54) as a co-ordinate of a sensing event and the other one of the pair of rows is re-selected (55, 53) while at least the column of the matrix sensor network is simultaneously read. If a sensing event is detected (51) the column and the re-selected other one of the pair of rows are identified (52, 54) as a co-ordinate of a sensing event.

FIG. 8 schematically illustrates an application of the method. In the illustrated table, the rows at labelled in the first column. In the example, there are 16 rows. The second column indicates where a sensing event occurs. There are two sensing events at row 5 and row 12. The remaining columns indicate time slots.

In each time slot a different group of rows is concurrently selected and accompanied by a simultaneously reading of at least one column of the matrix sensor network to detect a sensing event. The detection of a sensing event is labelled using T. The non-detection of a sensing event is labelled using N.

The rows selected in a particular time slot are indicated using a two-headed arrow.

The selection of groups of rows is in accordance with FIG. 6 except that a CHECK PHASE C is used for the other half rows if a sensing event is recognised on the previous slot.

It is assumed that it is recognised that one or more sensing events has occurred but that the quantity of the sensing events cannot be determined. The method may be simply optimised if the quantity of touches were known

Slot 1: All rows are selected and tested to sense one or more sensing events. One or more sensing events are detected (T)

Slot 2: Rows 1-8 are not selected and tested but Rows 9-16 are selected and tested. One or more sensing events are detected (T) on Rows 9-16.

Slots 3: A CHECK PHASE. Rows 1-8 are selected and tested and Rows 9-16 are not tested and selected. One or more sensing events are detected (T) on Rows 1-8. As a sensing event is detected during a CHECK PHASE a further search of this space will be required.

Slots 4 to 8: Rows 9 to 16 are searched.

Slot 4: Only Rows 9-12 are selected and tested. One or more sensing events are detected (T) on Rows 9-12.

Slots 5: A CHECK PHASE. Only Rows 13-16 are selected and tested. No sensing events are detected (N). The Rows 13-16 are eliminated for subsequent time slots as indicated by dark shading.

Slots 6 to 8: Rows 9 to 12 are searched.

Slot 6: Only Rows 9-10 are selected and tested. No sensing events are detected (N). The Rows 9-10 are eliminated for subsequent time slots as indicated by dark shading.

Slot 7: Only Row 11 is selected and tested. No sensing event is detected (N). The Row 11 is eliminated for subsequent time slots as indicated by dark shading.

Slot 8: Only Row 12 is selected and tested. A sensing event is detected (T) on

Row 12. A sensing row solution is therefore Row 12. In the event that block 58 is implemented, this slot is not required as the sensing row solution can be deduced from the result of the previous slot.

Slots 1 to 8: Rows 9 to 16 are searched as a consequence of the result of slot 3.

Slot 9: Only Rows 1-4 are selected and tested. No sensing events is detected (N). The Rows 1-4 are eliminated for subsequent time slots as indicated by dark shading.

Slot 10: Only Rows 5-6 are selected and tested. One or more sensing events are detected (T) on Rows 5-6.

Slots 11: A CHECK PHASE. Only Rows 7-8 are selected and tested. No sensing events are detected (N). The Rows 7-8 are eliminated for subsequent time slots as indicated by dark shading.

Slot 12: Only Row 5 is selected and tested. A sensing event is detected (T) on Rows 5. A sensing row solution is therefore Row 5.

Slot 13: A CHECK PHASE. Only Row 6 is selected and tested. A sensing event is not detected (N) on Rows 6. The Row 6 is eliminated for subsequent time slots as indicated by dark shading.

Slots 8 and 12 result in a sensing solution (R). CHECK PHASEs are used in slots 3, 5, 11, 13 (C).

All rows have now either been eliminated or represent sensing solutions. The method then resets and restarts.

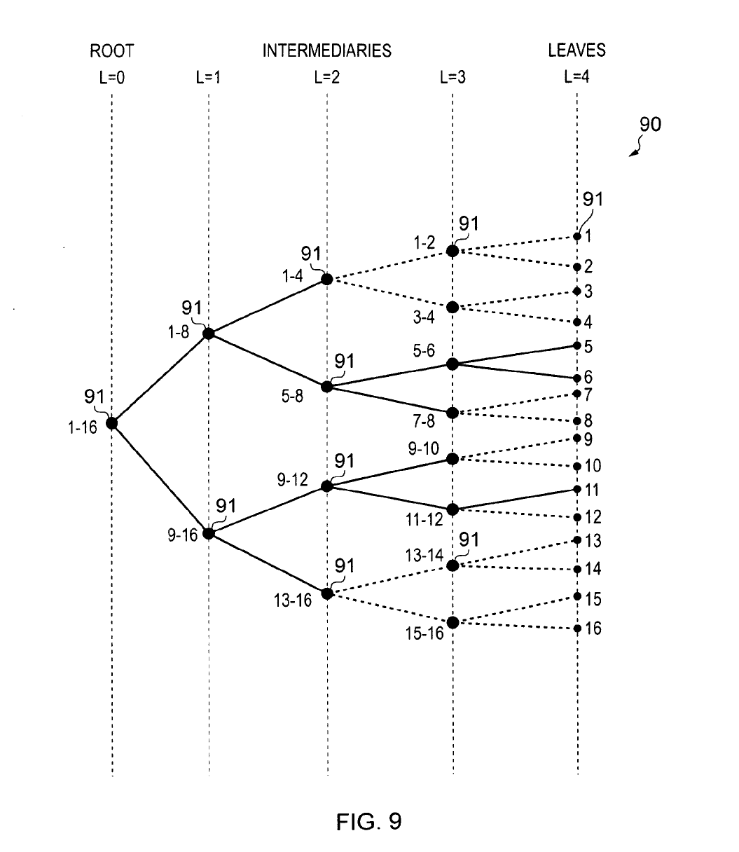

FIG. 9 schematically illustrates a graph which can be used to schematically illustrate another search strategy used to identifying multiple simultaneous sensing events.

The rows 22 may be logically divided into groups each of which is associated with a node of a graph 90. FIG. 9 schematically illustrates an example of such a graph 90.

The Figure schematically illustrates a rooted tree graph 90. The graph 90 comprises a plurality of nodes 91.

Each node 91 can be labelled either a root node, an intermediary node or a leaf node. The root node (i=0) does not connect upwards to another node and connects downwards to plural child nodes. An intermediate node (i=1, 2, 3) connects upwards to a single parent node and connects downwards to plural child nodes. A leaf node (i=4) connects upwards to a single parent node and does not connect downwards to any nodes.

Each node has an order (i) defined by the minimum number of connections separating it from the root of the graph.

Each node is associated with a group of rows. Groups associated with the nodes of the same order i are non-overlapping and cover, in combination, all the rows

The illustrated graph is an N-ary tree and each intermediate node has N child nodes. If the number of rows is N^{M} , there are Nⁱ groups of size N^{M-i} for order i.

In the illustrated example, if the number of rows is 2^{M} (e.g. 2⁴) there are 2ⁱ groups of size 2^{M-i} for order i. There is therefore 1 root node associated with a group of size 16 rows. The root node has two first order intermediary child nodes each of which is associated with a group of size 8 rows. Each first order intermediary node has two second order intermediary child nodes each of which is associated with a group of size 4 rows. Each second order intermediary node has two third order intermediary child nodes each of which is associated with a group of size 2 rows. Each third order intermediary node has two fourth order leaf child nodes each of which is associated with a group of size 1 row.

The identification of a co-ordinate of a sensing event may be considered a journey through connected nodes of the graph 90.

(i) Only when the journey involves a node 91 that has not been visited before is there concurrent selection of the group of rows associated with that node and there is simultaneous reading of one or more columns of the matrix sensor network to detect a sensing event.

(ii) The journey involves a return upwards through the graph one connection to the parent node if a sensing event is not detected during concurrent selection of the group of rows associated with the current node.

(iii) The journey involves a return upwards through the graph one connection if all the child nodes have been visited.

(iv) The journey involves an advance downwards through the graph one connection to an unvisited child node if a sensing event is detected during concurrent selection of a group of rows associated with the current node.

(v) The journey involves an advance downwards through the graph one connection to an unvisited child node if having returned upwards to a parent node there is a downwardly connected node that has not been visited.

If a sensing event is not detected on a first visit to a node, the status of all the nodes in a graph downwardly connected from that node are resolved as inactive. If a sensing event is determined at a node that is not downwardly connected to another node, the status of the node is resolved as active. The active nodes identify the row co-ordinates of sensing events. The method terminates when the status of each leaf node has been determined.

As used here ‘module’ refers to a unit or apparatus that excludes certain parts/components that would be added by an end manufacturer or a user.

The blocks illustrated in the Figs may represent steps in a method and/or sections of code in the computer program. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1-31. (canceled)

32. A method comprising:
concurrently selecting a group of rows in a sensor network;
simultaneously reading at least one column of the sensor network to detect a sensing event;
if a sensing event is not detected, eliminating the group of rows from further selection.

33. A method as claimed in claim 32, further comprising, if a sensing event is detected at a column, while the group of rows are concurrently selected, then:
concurrently re-selecting a second group of rows consisting of a subset of the group of rows, while at least the column of the sensor network is simultaneously read.

34. A method as claimed in claim 33, further comprising, if a sensing event is detected with respect to the second group of rows, then:
concurrently re-selecting a second subset of the second group of rows while at least the column of the sensor network is simultaneously read.

35. A method as claimed in claim 34, further comprising, if a sensing event is not detected with respect to the second group of rows, then:
concurrently re-selecting a third subset of a third group of rows while at least the column of the sensor network is simultaneously read, wherein the third group of rows consists of another subset of the group of rows.

36. A method as claimed in claim 32, further comprising:
if a sensing event is detected at a column, while the group of rows are concurrently selected, then:
concurrently re-selecting one half of the group of rows, while at least the column of the sensor network is simultaneously read.

37. A method as claimed in claim 36, further comprising:
if a sensing event is detected with respect to the re-selected rows, then:
concurrently re-selecting one half of the re-selected rows while at least the column of the sensor network is simultaneously read; and
if a sensing event is not detected with respect to the re-selected rows, then:
concurrently re-selecting the other half of the group of rows while at least the column of the sensor network is simultaneously read.

38. A method as claimed in claim 36, further comprising:
if a sensing event is detected at a column, while the group of rows are concurrently selected, and the group of rows consists of only a pair of rows, then
re-selecting one of the pair of rows while at least the column of the sensor network is simultaneously read and
if a sensing event is detected identifying the column and the re-selected one of the pair of rows as a co-ordinate of a sensing event.

39. A method as claimed in claim 36, further comprising:
if a sensing event is detected at a column, while the group of rows are concurrently selected, and the group of rows consists of only a pair of rows, then
re-selecting one of the pair of rows while at least the column of the sensor network is simultaneously read and
if a sensing event is detected identifying the column and the re-selected one of the pair of rows as a co-ordinate of a sensing event and
if a sensing event is not detected identifying the column and the other one of the pair of rows as a co-ordinate of a sensing event.

40. A method as claimed in claim 32, further comprising:
if a sensing event is detected at a column, while the group of rows are concurrently selected, and the group of rows consists of only a pair of rows, then
re-selecting one of the pair of rows while at least the column of the sensor network is simultaneously read and
if a sensing event is not detected identifying the column and the other one of the pair of rows as a co-ordinate of a sensing event;
if a sensing event is detected identifying the column and the re-selected one of the pair of rows as a co-ordinate of a sensing event and
re-selecting the other one of the pair of rows while at least the column of the sensor network is simultaneously read and
if a sensing event is detected identifying the column and the re-selected other one of the pair of rows as a co-ordinate of a sensing event.

41. A method as claimed in claim 32, wherein the rows are logically divided into overlapping groups of different sizes and wherein only previously unselected groups of rows are available for concurrent selection as a group.

42. A method as claimed in claim 32, wherein the rows are logically divided into groups each of which is associated with a node of a graph wherein the graph comprises a plurality of nodes and each node connects upwards to either no nodes or a single node and each node connects downwards to either plural nodes or no nodes and wherein identification of a co-ordinate of a sensing event involves a journey through connected nodes of the graph, wherein the journey involves a node that has not been visited before there is concurrent selection of the group of rows associated with that node and the simultaneous reading of one or more columns of the sensor network to detect a sensing event.

43. A method as claimed in claim 42, wherein the journey involves a return upwards through the graph one connection if a sensing event is not detected during concurrent selection of a group of rows.

44. A method as claimed in claim 42, wherein the journey involves a return upwards through the graph one connection if all the downwardly connected nodes have been visited.

45. A method as claimed in claim 42, wherein the journey involves an advance downwards through the graph one connection to an unvisited node if a sensing event is detected during concurrent selection of a group of rows.

46. A method as claimed in claim 42, wherein the journey involves an advance downwards through the graph one connection to an unvisited node if having returned upwards to a node there is a downwardly connected node that has not been visited.

47. A method as claimed in claim 42, wherein
if a sensing event is not detected on a first visit to a node, the status of all the nodes downwardly connected to that node are resolved as inactive;
if a sensing event is determined at a node that is not downwardly connected to another node, the status of the node is resolved as active; and
identifying the co-ordinates of sensing events using the active nodes.

48. A method as claimed in claim 47, wherein the method terminates when the status of each node that is not downwardly connected to another node, has been determined.

49. An apparatus comprising:
a sensor network comprising: a first plurality of rows, a second plurality of columns, and a third plurality of sensor elements wherein each sensor element is associated with a unique combination of a row and a column selection circuitry configured to concurrently select one or more of the first plurality of rows;
reading circuitry configured to concurrently read the second plurality of columns during a concurrent selection; and
control circuitry configured to select which of the first plurality of rows are selected and, if no sensing event is detected by the reading circuitry during a concurrent selection of selected rows, then eliminating the selected rows from further selection.

50. An apparatus as claimed in claim 49, wherein the control circuitry is configured, when a sensing event is detected at a column while the group of rows are concurrently selected, to concurrently re-select one half of the group of rows, while at least the column of the sensor network is simultaneously read.
